(19) United States
(12) Patent Application Publication
(10) Pub. No.: US 2020/0068866 A1
(43) Pub. Date: Mar. 5, 2020

(54) MAGNETIC INDUCTION HEATING FOR PEST CONTROL

(71) Applicant: PERPETUAL RESEARCH CONSULTANCY LTD., Marlow (GB)

(72) Inventor: Michael John Taylor, Marlow (GB)

(73) Assignee: PERPETUAL RESEARCH CONSULTANCY LTD., Marlow (UK)

(21) Appl. No.: 16/609,595

(22) PCT Filed: May 24, 2018
(86) PCT No.: PCT/IB2018/053716

§ 371 Date: Oct. 30, 2019

(30) Foreign Application Priority Data
May 24, 2017 (GB) 1708332.0

(51) Int. Cl. A01M 1/22; A01G 7/06; H05B 6/06; H05B 6/36

(52) U.S. Cl. CPC A01M 1/226; H05B 6/36; H05B 6/06; A01G 7/06

(57) ABSTRACT

The present invention describes a method and associated equipment for using irradiated, magnetic energy (6) to carry out pest control in plants and vegetable matter e.g. agricultural crops and vegetable foodstuffs. The invention is also suitable for pest control in woody materials and is useful for any material, which is reasonably transparent to B-field energy, to attack a pest (1) that is more opaque to B-field energy than the substrate on or within which the pest (1) is located, such as wasps inside a wall cavity, or slugs and snails under the soil, or mosquito larvae in water.

### TECHNICAL FIELD

Chemical pesticides are recalcitrant to biodegradation, so persist in the environment as toxic residues in the soil, on the plant and in the pest, and find their way into the local food chains, groundwater and/or crops. Public disquiet has been slowly growing with the realisation that human and environmental health are being damaged by such toxic agrichemicals, especially with overuse and other abuses. The application of DDT, for example, is now considered scandalous, and is banned from agricultural use in many countries.

Many applications of physical energy, in agriculture and otherwise, rely on the concept of irradiation. However, the very word radiation contains connotations of harm in the public consciousness. Too often, though, no distinction is made between ionising radiation (such as “radioactivity”, x-rays and gamma rays) and other, safer forms of radiation (such as sound, light, electric fields and magnetic fields). All forms of radiation can, of course, cause damage to biological material under certain circumstances, and it is this very aspect of specificity that makes irradiated energy so promising for agricultural pest control. The damage mechanisms vary from one type of radiation to another, but this invention centres on the conversion of absorbed radiation into heat. Note that the entire body of an organism need not be bulk heated; it may be that only a small but sensitive component is heated, killing or incapacitating the pest.

At the heart of radiation theory lies the concept of a wave. The energy of a wave is proportional to its frequency, and thus high-frequency radiation would be expected to be most damaging to biological material. In many instances this is correct, but the correlation is greatly confused by the many ways in which various forms of radiation can be absorbed. For example, microwave radiation (EMR with frequencies of between 1 GHz and 300 GHz) is absorbed by water molecules deep inside biological material via a process known as dielectric heating. Infrared “heat” (EMR with frequencies two orders of magnitudes higher than p-waves) is generally surface-absorbed by biological materials via atomic lattice disturbances. Ultraviolet radiation (EMR with two orders of magnitude higher frequencies than infrared) is again surface-absorbed but by electron excitation. Gamma radiation (EMR five orders of magnitude higher frequencies than UV) is absorbed at depth by fully ionising atoms.

Hence, wave frequencies alone cannot be used as a general guide to predict how biological materials might respond to irradiation. Materials respond to (i.e. absorb) narrow bands of radiation to which they are opaque. At other frequencies, the radiation simply passes straight through with little interaction, and the material is transparent or translucent to these frequencies. This property of selective absorption is used in the present invention by considering the selective heating of the target pest (or portions thereof), while leaving the substrate (i.e. the crop material upon which, or deep within which, the target pest resides) unaffected.

As well as the types of radiation and the frequencies applied, both the intensity and period of irradiation (which together define the dosage) can be varied. Furthermore, physical radiation is usually directable and focusable, meaning that it can be targeted precisely to where it is required. Hence, great scope exists to tune, concentrate and direct specific physical energy for specific agricultural applications.

Finally, physical radiation does not leave a residue either on the target pest or on the substrate. This may be a mixed blessing for users: repeated infestations would require repeated treatments; however, the lack of residue means that the methods are environmentally “friendly” since the dead target pest can be incorporated into the local food web without causing further damage to the food chain, and the crop will be left clean and ready for human consumption. This lack of residue may make the process especially useful for organic farmers. Another group for whom this technology may be of particular interest is to farmers in developing countries, where the high cost and general unavailability of pesticides prohibits their use. However, all farmers will be interested in the concept of physical energy for pest control, which plays positively into both the environmental and sustainability agendas.

A general concern of using physical energy for pest control is the ethical consideration. In the military context, where similar technologies have been developed for “Directed Energy” weapons, international conventions exist which specifically outlaws their use against humans. Use is confined to “blinding” missile seekers, or striking at a component on a printed circuit or computer motherboard. In agriculture, horticulture and other forms of pest management, use of the present invention is initially confined to invertebrates such as insects and molluscs; use against vertebrates, such as mice inside a store of corn, or moles or badgers within their burrows, may be considered unethical. This is particularly pertinent in the context of animal experimentation. However, future use against vertebrate targets could be considered once the ethical situation has been more firmly established.

### BACKGROUND ART

Since Neolithic times, farmers have practised various forms of pest control, such as the use of burning sulphur as a fumigant. The Roman author Pliny the Elder (A.D. 23-79) recorded most of the earlier insecticide uses in his Natural History. Included among these were the use of gall from a green lizard to protect apples from worms and rot (see http://ipmworld.umn.edu/ware-intro-insecticides). During the mid-1800s, scientific methods were being used to properly investigate the concept, and in 1877 the first large-scale use of pesticides was to control the Colorado beetle in potato crops using water-insoluble arsenates (e.g. London Purple and Paris Green). Other rudimentary pesticides were quickly developed including nicotine, tar oils and copper sulphate. By the 1940s, the powerful pesticidal properties of the chlorinated compound DDT were being investigated. DDT was found to be more effective and persistent than any previous pesticide. An entire group of chlorinated compounds followed. Crop losses were cut sharply, and farmers saw a future free of pests.

Now, chemical pesticides are no longer seen as a panacea for pest control. They are slow acting, and frequently do not kill the pest quickly enough to prevent crop losses from viruses transmitted to them, leading to overuse as an insurance that they will be effective. Developing a new pesticide active ingredient costs over £200M, and takes up to 9 yrs. For farmers, approximately 35% of variable costs for combinable crops will be for applying pesticides, totalling around £160/ha. In vegetables, the cost is even higher. This is expensive, more so if they do not work. They also lack specificity, often killing the insects beneficial to the farmer as well as the pest/s being targeted. Natural selection causes a build-up of tolerance to pesticides, meaning ever stronger doses and formulations need to be used to compensate for growing resistance, adding extra costs for the farmer who often overuses them as an insurance that they will be effective. Pesticides are also recalcitrant to biodegradation, so persist in the environment as toxic residues in the soil, on the plant and in the pest, and find their way into the local food chains, groundwater and/or crops. Public disquiet has been slowly growing with the realisation that human and environmental health are being damaged by such toxic agrichemicals, especially with overuse and other abuses. The application of DDT, for example, is now considered scandalous, and is banned from agricultural use in many countries. The organic movement has tried to introduce a holistic and natural approach to all aspects of farming—although not rejecting the need to control pests out of hand, the movement does seek to redress the sustainability issues associated with pesticides.

There are increasing threats to invertebrate pest management world-wide. Oilseed rape (OSR) growers in particular are suffering loss of crops due to aphids, pollen beetle, slugs and cabbage stem flea beetle (CSFB) attacking new growth “with terminator-like determination” as effective pesticide treatments become unavailable. Insect resistance to pyrethroid, a frequently-used pesticide ingredient, is growing; neonicotinoid-treated seed cannot be planted following the imposed restrictions; metaldehyde, the main organic compound used against slugs, is leaching into waterways with water quality standards being compromised. This crop loss is discouraging farmers from growing OSR, with a decrease of around 20% in planted area in 2016. For horticulturalists, vine weevil is a serious pest causing £40 million/year damage to the UK horticulture industry and £5 billion worldwide. Bifenthrin, an effective pyrethroid pesticide against vine weevil, has been withdrawn in the UK. Pollution is a costly problem for those outside farming, too: Anglian Water estimates their cost to set up water treatment plants for metaldehyde is £600 million, plus £17 million/year to run the systems. This represents a 21% increase in customers' water bills.

Costs of harm resulting from pesticide use are significant. These are often hidden, long term and underestimated. The world pesticide industry is valued at US $52 billion, and the costs of harm have recently been assessed to be similar—pesticide use might now therefore have outreached its benefits.

However, there are few alternatives to chemical pesticides—any such method must be perceived as being safer, as cheap and as easy to use. Some biological methods have been successfully employed, for example the release of predators of pests (such as ladybirds). Gene editing techniques are being explored to enhance crops with natural pesticides, and to synthesis sterile male pests that breed with the natural population and so decrease their numbers. But genetic manipulation has growing public concerns of its own, and other biological methods are not without their problems.

Current best practice combines the minimal use of agrichemicals with biological and preventative methods in a scheme known as Integrated Control. However, physical (energetic) means, as opposed to chemical or biological, can also be used to control pests. Although used for years, the application of physical energy for pest control is still much understated.

One method common in food preparation areas is an ultraviolet light trap which attracts flies in conjunction with electrified wires to electrocute the enticed insects. Other forms of light traps have been used against the codling moth and tobacco hornworm. UV light is also used to cause algae to flock, allowing its removal by pond filters.

Other types of physical energy have been explored for pest control. For a general discussion, see: Sterilization of Screw-worm Flies with X-rays and Gamma-rays, C Bushland, D E Hopkins—Journal of Economic Entomology, 1953; Scientific Aspects of Pest Control, Publication 1402 National Academy of Sciences—National Research Council Washington, D.C., 1966; Microwave and Radio-Frequency Technologies in Agriculture: An Introduction for Agriculturalists and Engineers Graham Brodie, Mohan V. Jacob, Peter Farrell, Walter de Gruyter GmbH & Co KG, 1 Jan. 2016.

Furthermore, it has recently been discovered that if the Indian meal moth is exposed to certain wavelengths of sound during the egg laying process, their reproduction is reduced by 75%, for example, see Kirkpatrick R L and Harein P K, Inhibition of reproduction of Indian-meal moths, Plodia interpunctella, by exposure to amplified sound. J Econ Entomol 58(5):920- 921 (1965). Sound waves had a similar effect on flour beetles, for example, see Mullen M A, Infrasound retards development of Tribolium castaneum and Tribolium confusum. J Stored Prod Res 11:111-113 (1975).

In US patent application no. US2006024195A1, the authors use MHz-frequency electric fields (as opposed to the MHz magnetic fields of the present invention) to kill insects on fruit. They place the samples to be treated between a pair of parallel metal plates alternately charged +ve/−ve at MHz frequencies to several kV. The relevant exposure times are in the region of seconds (Para 0022), similar to those contemplated by the present invention. The authors also quote the fact that the electrical conductivity of insects is higher than for plants and states that this is important to the operation of their invention (Para 0050 and 0059). The disadvantage of the system described is that, for a crop, you would need to employ a single horizontal charged plate and use the ground itself as the second plate, or have a pair of parallel plates held vertically and run the crops between them: either way, there is a good chance of an electrical breakdown to earth under the high electric field in an uncontrolled crop situation, especially if the crop is wet or some protruding metal gets in the zone. This is not the case with the magnetic field used in the present invention, where no electrical breakdown will occur, and the system according to the invention can rapidly shut down if the inductance is not what is expected (e.g. a cat runs into the B-field, or a metal wire sticks up).

Published U.S. Pat. No. 5,162,014 describes a method for treating honeybees for mite or parasite infestation by exposing the hive to a magnetic field, which is limited, such that it combats the mite or parasite infestation, but the magnetic field is not so strong as to affect the viability of the bees themselves. This document describes how a 100 gauss (10 mT) magnetic field has been observed, under a microscope to kill an Acarapis woodi Rennie mite. Such a (permanent as opposed to oscillating) magnetic field may be created with electromagnets, permanent magnets, or other means known in the art for inducing magnetic fields. The exposures described are for upwards of 20 days. An oscillating field may kill the mites in a matter of moments, although this may also kill the bees.

U.S. Pat. No. 5,339,564 tries to achieve a similar effect to that of the present invention, except that the disclosure in this document uses electromagnetic (as opposed to magnetic) fields centres on 147 MHz. This couples with animals cellular mitochondria and disrupts its operation, while leaving plant mitochondria unaffected. The power density is low enough not to dielectrically heat the water, and this document also states that microwaves are useless for killing agricultural pests due to their heating water in plants as well as animals.

US patent application no. US2017020122A1 describes a high-voltage contact method for setting up a “storm of electrons” to flow through a plant to stimulate growth, destroyed pathogens or nematodes or insects in the plant or soil. However, there is no mention of voltages, frequencies, or exposure times in this document. There is also no mention of contactless induction heating, although magnetic fields are suggested as enabling additional electric currents to be set up within the plant structures.

U.S. Pat. No. 2,223,813A is very similar to the present invention, and is highly effective at killing a wide variety of insects including eggs, larvae, pupae and adults in 1 s. The author suggested the effect of his invention is to break down cell structure under microwave 5-25 GHz E-field harmonics of several hundred volts/cm. No mention is made of the effects of B-fields, if any, that were produced by his invention.

WO88009616A1 shows a device being towed behind a tractor such that it damages insects, but leaves plants undamaged. However, this is an invention relying on powerful microwaves that would reflect from the soil and cause difficulties with regards to electromagnetic compatibility (EMC) regulations. The present invention would produce a similar beneficial effect without producing powerful inherent electromagnetic effects.

U.S. Pat. No. 4,524,079 uses magnetic field effects to sterilise food and containers of fungi, moulds, spores, viruses, protozoa and algae in a manner like the present invention. However, large B-fields of up to 100 T at low frequencies of below 500 kHz are used for exposure times less than 10 ms, and as short as 25 μs. The present invention uses small, millitesla B-fields at MHz frequencies and second timescales, and is for larger organisms such as insects.

Finally, U.S. Pat. No. 5,645,697 applies a 7 kHz frequency B-field in the pipe of a beer delivery system for 10 weeks, which interferes with the electron transport system within micro-organism cells to inhibit uptake of nutrients, leading to cell stasis or death. This is again similar to the present invention, except the present invention uses MHz frequencies for a second duration, and for larger organisms.

Microwave and Radio-Frequency Technologies in Agriculture: An Introduction for Agriculturalists and Engineers Graham Brodie, Mohan V. Jacob, Peter Farrell, Walter de Gruyter GmbH & Co KG, 1 Jan. 2016 cites the use of magnetic field (B-field) heating as being superior to electric field (E-field) heating, but states that because most agricultural and forestry materials are non-magnetic, therefore dielectric heating, which involves the interaction between the electromagnetic electric field and the material, is the most common mechanism for electromagnetic heating. No uses of B-field induction heating are given.

### SUMMARY OF INVENTION

The present invention provides a method and associated equipment for using irradiated, magnetic energy to carry out pest control in plants and vegetable matter e.g. agricultural crops and vegetable foodstuffs. The invention is also suitable for pest control in woody materials, such as woodboring invertebrates e.g. Ambrosia beetles; Woodboring weevils; Bark borer beetle; Common furniture beetle; Deathwatch beetle; House longhorn beetle; Powderpost beetle; Wharf borer. It is also useful for any other material, which is reasonably transparent to B-field energy, to attack a pest that is more opaque to B-field energy, such as wasps inside a wall cavity, or slugs and snail under the soil, or mosquito larvae in water.

Magnetism is a complex branch of physics; it is only briefly touched upon in undergraduate physics courses. However, because of its wide-ranging applications, it is also a well-studied branch. When discussing magnets, we often talk about “field strength” etc. This use of the term “field” in this context is unfortunate, given the word's more tradition use in agriculture. As will be seen shortly, there are other terms in magnetism, but terms such as “magnetic field” cannot be entirely avoided.

Magnetism can be produced in two ways: (i) using a permanent magnet, and (ii) electromagnetism. Permanent magnetism is concerned with weak, steady-state magnetic fields, and is here of a passing interest only. Electromagnets are produced by moving electric charges, usually via current-carrying electric conductors. These are temporary (i.e. disappear when the electric current ceases), and can produce powerful and adjustable fields, both steady-state and oscillatory. Steady-state electromagnetism results if direct current (DC) electricity is used, or oscillating magnetism if alternating current (AC) electricity is used. (The frequency of the oscillating magnetic field is defined by, and equals that of, the alternating electric current.) It is the oscillatory aspect of such fields (especially at high-frequency) that are of interest to pest control here, although the ability to control and focus the electromagnetic field strength is also important.

The “strength” of a magnetic field is often given by its magnetic flux density, B. Properly, B is a measure of the energy density of the magnetic field. The unit of B is the tesla, T.

A good permanent magnet has a value of B of around 1 T. The steady-state magnetic field of the Earth is thought to originate with electric currents deep within the core of the plant, and the terrestrial field is around 4×10⁻⁵ T. The highest flux densities are produced by magnetic flux compressors, where pulsed fields in excess of 10³ T can be achieved on microsecond timescales. More typically, an air-cored solenoid (1 turn/mm, 1 A current) has a value, B=1×10⁻³ T within it. At the ends of the solenoid, the field diverges (as at the poles of a bar magnet); the value of B at the ends of a solenoid can be show to be half that at the core.

Another quantity in magnetism is the magnetic flux, φ, and φ=B A, where A is the perpendicular area intersecting the magnetic flux, and is a measure of the total magnetic energy available within the field. “Lines of flux”, or “field lines”, are often used on diagrams of magnets to depict their fields: the closer the lines, the higher the value of the flux density B, and the absolute number of lines is a measure of the flux, φ.

The language of magnetism is Victorian in origin, and comes from a time when there was much uncertainty over the origins and nature of magnetism. Lines produced by sprinkling iron filings about a magnet reinforced the idea that magnetism flowed like a fluid. It is now understood that magnetism is a result of the relativistic motion of electric charges, and hence not a “real” (i.e. fundamental) force at all, but an “apparent” force.

All materials are “magnetic”. However, some materials are more magnetic than others. There are various ways to quantify this. The magnetic susceptibility, χ of a material will be used here. The term is nicely descriptive of what it tries to convey—i.e. a material's susceptibility to being magnetised.

Materials can be divided into five types with respect to their magnetic susceptibility:
1. Diamagnetic, with χ small, negative and independent of B and temperature.
2. Paramagnetic, with χ small, positive, independent on B and decreasing with increasing temperature.
3. Ferromagnetic, metallic with χ large (>>1), and strongly dependent on B and temperature.
4. Ferrimagnetic, as with ferromagnetic, but for non-metallic ferrites (oxides of iron).
5.Antiferromagnetic, with χ small, positive, and dependent on B and temperature.

Magnetic susceptibility is a unitless quantity. Essentially, it is a ratio of a material's ability to increase (or decrease) the magnetic flux density with respect to a vacuum. χ=(Bₛ/Bₒ−1), where Bₒ is the value of magnetic flux density in a vacuum (air in practice), and Bₛ is that of the material of interest. χ is found graphically by comparing the magnetic flux density of a toroidal solenoid with and without the material as a core. A negative value of χ reduces the flux density. Some values of χ are given below (Electricity and Magnetism, 3rd Edition, 1980, p. 346 & 356):

| | |
|---|---|
| Copper | −16.7 × 10⁻⁵ |
| Water | −0.91 × 10⁻⁵ |
| Aluminium | 2.2 × 10⁻⁵ |
| Oxygen | 0.19 × 10⁻⁵ |
| “Soft” iron | 1.5 × 10³ |
| Chrome steel | 2.4 × 10³ |
| Mumetal | 2.0 × 10⁴ |
| Supermalloy | 1.0 × 10⁵ |

Mumetal and supermalloy are nickel-iron alloys, and are often used in magnetic shielding.

Significant magnetic energy is transferred to a magnetic material (i.e. one with a high value of χ) when the material “cuts” magnetic lines of flux. The rate of cutting and the magnetic flux density together give the rate of energy transfer. (The total number of lines of flux cut is a measure of the total energy transferred.) The lines of flux can be cut by either moving the material in the magnetic field, or moving the field about the material. This latter method also includes oscillating the field (as per an electromagnet formed from an alternating electric current). If no movement exists, then no energy is transferred however strong the magnetic field is. Furthermore, if the movement occurs along the lines of flux, then no lines are cut either, and again no energy is transferred. (Moving along the lines of latitude thus maximise the transfer of terrestrial magnetic energy. Note also that, when a field oscillates, lines are always cut.)

When magnetic energy is transferred, this is often to thermal energy within the material. Hence, if a material is placed near to a conductor carrying a high-frequency current (advantageously within a coil, spiral or helix) with a high-frequency oscillating magnetic field, some energy would be transferred and heating occurs inside the material. The value of χ helps determine the rate of energy transferred, with higher positive values of χ giving a higher energy transfer rate. The oscillating frequency also defines the rate at which that energy is transferred, with a higher rate of heating for higher frequencies.

With electrical conductors, a further process occurs. Free (conduction) electrons and other charges in materials (e.g. ions in solution) experience a force when they cut, or couple with, lines of magnetic flux, and are “induced” to move perpendicular to the field. The general process by which electric currents are generated by a changing magnetic field is called electromagnetic induction.

Electromagnetic induction is the underlying process of electrical generators. The effect can also be used to transfer thermal energy due to ohmic (electrical) resistance of these “induced” electrical currents. Materials thus get hot if left within an alternating magnetic field. This is true for any electrical conductor, and is independent of χ. Copper, for example, has a very low magnetic susceptibility, but a high electrical conductivity; hence, copper will heat up significantly when exposed to an oscillating magnetic field.

Electric currents are even induced in conducting material where an electric current cannot flow, for example in a copper disc rotating in a static magnetic field. Such currents are called eddy currents, and the energy of an eddy current ends up as thermal energy inside the material. This is the process by which magnetic brakes (e.g. on cars) work. In a more efficient process, the induced currents form a complete circuit—not eddies; and rather than simply wasting kinetic energy as heat, it can be recovered to charge an electric battery. The process of induced eddy and electric currents will be used to significant advantage in magnetic induction heating of pests, as described in the next section.

Finally, there is a geometric component to electromagnetic induction.

When magnetic energy is transferred by the oscillation of free electrons within a conductor, the path length travelled by the electron is known as the “mean free path”, λ. λ is a function of the square of the applied magnetic field's frequency, with a high frequency yielding a shorter λ. If this path is long compared to the perpendicular geometry of the conductor within the field, then little energy will be transferred. Hence, an iron rod placed in an AC solenoid will experience heating; however, iron filings placed within the same field will be heated far less if the filing's geometry is less than λ. Increasing the frequency at which the magnetic field oscillates decreases λ and hence increases the power transferred via magnetic induction.

The thermal power, P (in W/kg) transferred from a magnetic field to a body via magnetic induction heating is given by:

$$P = \frac{{π}^{2} {B}_{p}^{2} {d}^{2} {f}^{2}}{6 k ρ D} \qquad Equ . ( 1 )$$

where
Bₚ is the peak magnetic field (T),
d is the thickness of either a sheet or diameter of a cylinder (m),
f is the frequency of the magnetic field (Hz),
k is a constant equal to 1 for a thin sheet and 2 for a thin cylinder,
ρ is the resistivity of the material (Ωm), and
D is the density of the material (kg/m3).
   This equation is valid only where the frequency of magnetisation does not result in the “skin effect”; that is, the electromagnetic wave must fully penetrate the material. The skin effect is only relevant for good electrical conductors (i.e. metals) and high frequencies, and is unlikely to be an issue for pests.

It is not common for high-frequency oscillating magnetic fields to come to the public's attention, although they are very common in industrial heating applications of all kinds, from metalwork to resin setting and loosening tight nuts in car mechanics. One area where oscillating magnetic fields do meet the general public is with the inductive cooker hob. Here, specialist cooking pans with thick copper bases are placed upon a coil (the hob), and the copper heats when the hob (oscillating magnetic field) is switched on. The contents of the pan are then heated by thermal conduction—the contents are not directly (i.e. inductively) heated. Any non-electrically conducting objects remain unaffected directly, so for example the glass of the hob top remains cool if no pan is in place. Metal rings worn on the cook's hand may get hot, however, and so some care needs to be taken. The degree of care required with an electromagnetic hob is, inherently, no different from that taken with a classical electric element cooker, or a gas hob; if anything, induction heaters are far safer. The biggest difference lies in the lack of visibility when an inductively heated hob is switched on, although this can be countered by using a red light with the appearance of heat. Sometimes, a sensor detects the cooking pan, and the device does not switch on unless the pan is in place. Alternatively, if an unusual electrically conductive item is exposed to the field, the change in circuit inductance (a property that causes a voltage to be generated) can be detected and the power switched off automatically. This safety feature will be used to good effect in pest control below.

A metal detector is an electronic instrument which detects the presence of metal objects buried underground. They usually consist of a handheld unit with a sensor probe which can be swept over the ground or other objects. The simplest form of a metal detector consists of an oscillator producing an alternating current that passes through a coil producing an alternating magnetic field. If a piece of electrically conductive metal is close to the coil, eddy currents will be induced in the metal, and this produces a magnetic field of its own, changing the mutual inductance of the system. If another coil is used to measure the magnetic field (acting as a magnetometer), the change in the magnetic field due to the metallic object can be detected.

Typically, the frequencies of such induction heaters and metal detectors range over a few kilohertz (up to 400 kHz are common.) New megahertz heaters are said to exist, for example those being developed by C-Tech Innovations, although it is unclear whether these are purely magnetic or electromagnetic in nature. RF electrical transformers also have frequencies ranging up to 10 MHz. However, a promising technology is “wireless power transfer”. Here, RF magnetic energy (a few megahertz) has been used to transfer significant electrical power over many tens of centimetres using new “magnetic lenses” to focus the energy to where it is required (see “Magnetic Superlens-enhanced Inductive Coupling for Wireless Power Transfer”, Da Huang, Yaroslav Urzhumov, David R. Smith, Koon Hoo Teo and Jinyun Zhang, arXiv:1204.0231v1 [cond-mat.mtrl-sci] 2 Apr. 2012). In one famous demonstration, a 60 W light bulb has been lit at a distance of 2 m (see A. Kurs, A. Karalis, R. Moffatt, J. D. Joannopoulos, P. Fisher, M. Soljac, and M. Soljacic, Science 317, 83, 2007 http://science.sciencemag.org/content/317/5834/83.

The effects on biological material of RF magnetic fields is well characterised. In 1978, Nottingham University undertook a major study into the effects of megahertz magnetic fields on rat samples in order to better understand the effects of the then new nuclear magnetic resonance (NMR) imaging, see RF Magnetic Field Penetration, Phase Shift and Power Dissipation in Biological Tissue: Implications for NMR Imaging, P. A. Bottomley and E. R. Andrew, Phys. Med. Biol., 1978, Vol. 23, No. 4, 630643. It was found that at these frequencies, significant heating of animal tissue can occur. With the microsecond pulsed exposure times for NMR, this issue was not of importance for that application. However, with a continuously applied magnetic field, the heating is expected to be very significant.

In terms of electrical conductivity, plants can be modelled as mainly sugary water (non-electrical conductors) and can therefore be predicted to have an overall low predisposition to being heated by magnetic induction. Conversely, animals, composed of electrically conductive solutions of ionic salts and with an electrically conductive nervous system, would be predicted to have an overall high predisposition to being heated with RF magnetism. This means that a pest control system based upon irradiation of RF magnetism could be used to safely control pests.

RF magnetism (usually, but not necessarily, above 1 MHz), as opposed to lower frequency magnetism, is being proposed mainly because of the geometrical aspect of magnetic induction. Agricultural pests, particularly insects, are usually very small, and as Equ. (1) above shows, the power transferred by magnetic induction is proportional to d²; the smaller the size, the less power transferred. Increasing the frequency of the magnetic field compensates for this. However, because the temperature rise required to kill or disable a pest is low (internal heating of a few degrees Celsius), then the overall power requirements is likely to be low.

To test this, a simple mathematical model of a standard solenoid has been applied to heating a simple mathematical model of a slug (a small bag filled with 0.5% by 3 g mass salty water). A 3 cm long solenoid with 20 turns carrying a 27 MHz frequency current of 30 A produces a magnetic flux density of 25 mT, and heats the slug by 30° C. in a second. A lettuce leaf (modelled using the electrical conductivity of a maize leaf) heats up by 0.2° C. in a second under the same conditions. If this slug were to be living on a lettuce leaf and both were exposed to this magnetic field, the slug would die and the leaf would undergo no measurable heating. However, this is not to imply that uniform bulk heating of the slug (or any organism being treated) is necessary.

A higher frequency has increased heating effect, or would reduce the current required for any given heating. A frequency of 400 MHz would only require a current of 2 A for the same heating effect. This assumes uniform heating, and as already stated, this is not required: for example, if the nervous system was to be attacked, the electrical requirements would then be very modest.

The idea being posited here, of magnetic induction heating for pest control (MIHPC), is to apply a B-field at an optimised frequency (generally RF), intensity and duration to sufficiently damage the target pest (based upon the physical size of the pest and the chosen B-field characteristics), yet leave the plant unaffected. The optimisation process also ensures the process is as energy efficient as possible. Were the energy requirements to be excessive, or the period for dosage to be excessive, then the system of magnetic irradiation for pest control would be unattractive to the farmer.

There are any number of conceptual designs for this technology. One proposed concept is to replace the agrichemical sprayer at the back of a tractor with an appropriate B-field source, and then apply as per normal by driving up and down the field with a specified kill zone applied to the part of the crop where the invertebrates live. Up to 100 kW of electrical power can be tapped off large tractors. Another concept could be a system that fits on the back of a person undertaking the treatment, and the magnetic energy kill zone then “sprayed” onto a small area, a system very much like a horticultural agrichemical sprayer. Were the energy requirement to be very low, then, conceivably, a hand-held device could be used, similar to a tin of fly spray for the control of ants or houseflies by a residential user, for example. Another use could be for control of termites on wooden structures, where small permanent magnetic fields can be stationed by coils around the building's struts. Yet another concept would be for control of woodworm or death-watch beetle within wooden beams. Leaf blotch miner, which can cause severe crop loss in costly baby-leaf salads, could be targeted. The technology would enable the organic sector, worth around £2 billion/year in the UK, to more efficiently control their pests, increasing yields and quality and allowing fairer competition, encouraging this sector to grow. Food could be treated during packaging in third-party countries, killing invasive species such as fruit flies and the Colorado potato beetle prior to importing without leaving chemical residues, reducing spend and regulatory barriers to trade, and reducing the detectable pesticide residues in harvested produce. Grain in silos could be treated for weevil, preventing up to one third of the world grain crop being lost during storage. Wireworm in the soil can be targeted: this causes significant damage with autumn and spring-sown cereals; infestations can cause losses of up to 0.6 t/ha, and potato losses in the range 5-25% have been reported. The amenity sector shares many of these same pesticide problems, but includes issues such as the destruction of wasp's nests, and the added problem of highly-polluting counterfeit products being used by small contractors.

The use of radio frequency magnetic induction heating for pest control (MIHPC) is a transformational, disruptive innovation, and offers an exciting new one-stop response to the pressing need for alternatives to pesticides. To date, this has never been attempted, or even considered as an option. The concept relies on animal material being hundreds of times more electrically conductive than plant material, so animal material would therefore undergo a proportionally faster rate of inductive heating.

MIHPC is contactless, and does not need electrodes to be in contact with a target pest and this pest control method would prevent environmental pollution, there being no chemical residues associated with it. Furthermore, with a suitable delivery system, invertebrates could be killed on or inside of plants, or even when below ground or hidden deep within pots.

At an estimated £6 per hectare for the electrical requirements, the proposed technology provides an affordable, significant step-change in productivity as well as ending the negative impacts associated with pesticides for the grower. New products, processes and services will be generated because of this technology, with new companies developing who would offer agricultural, horticultural and residential products and services for this treatment.

MIHPC can reach invertebrates hidden deep within the interior of plants and low electrical conductivity structures such as walls. Agrichemicals tend to merely reach the surfaces. For example, a cabbage stem flea beetle larvae deep within the petiole of an oilseed rape plant leaf can be killed with MIHPC, whereas with conventional pesticides this is difficult without systemic treatment such as neonicotinoids (now banned from use due to their effect on the environment). Slugs in the soil, or vine weevil in the root balls of planted pots can be targeted using this technology. The soil's electrical conductivity would need to be lower than the target to avoid heating the soil and, as FIGS. 1 & 2 show, this may be more appropriate for sandy soils than loamy soils, depending on the electrical conductivity of the part of the pest being targeted.

Another consideration is that pests cannot out-evolve their inherent electrical characteristics. Increasingly, agricultural pests are becoming resistant to pesticides, and new chemicals are having to be developed, but pests will not become resistant to magnetic heating. This new MIHPC technology is thus immune to overuse by farmers as an insurance against it not working—farmers can use it as liberally as they wish without fear that the pests will build up any resistance.

The cost of developing a pesticide active ingredient is around £500M, and takes over nine years and is repeatedly needed due to the build-up of resistance. MIHPC will only require developing once and MIHPC can be applied to a crop in the same manner as agrichemicals. A safety feature of this is that a narrow band of expected inductances can be set such that were a dog to run into the kill zone, or a piece of metal, then the unexpected inductance would trip the circuitry to momentarily power down the device.

Magnetic energy can be tuned to specific pests by frequency, intensity and duration dosage. One multi-tuneable MIHPC unit might therefore be used for different combinations of pests and crops.

New agrichemical solutions require extensive safety testing. MIHPC will not, saving time and expense during implementation. MIHPC relies solely on electrical energy. It is an enabling technology for the all-electric farmer, i.e. one who generates their own electricity and uses farm machinery entirely run by electricity, not diesel. (Such a farmer might live in a developing nation a long way from an agrichemical supply chain but with a source of electrical power, or be a farmer wishing to reduce their carbon footprint via local generation and use of electrical power. The use of electrically powered farm machinery, tractors etc., is seen to be increasingly attractive to the general farming community, too).

MIHPC technology is not restricted to producers of food, or indeed to plant-based substrates. Other uses might include attacking wood-boring pests, where magnetic energy can penetrate deep inside the interior of an oak beam, for example, or for attacking wasp's nests inside walls. MIHPC could, conceivably, be used to attack pests on animals, e.g. fleas and ticks on cats or dogs, or tapeworm in horses. The ability to focus magnetic energy of a specify frequency and dosage to specific pest sites may be of benefit here—the scale of the target is an important factor and the pet involved might be found to be immune from the effects. (This is not dissimilar the use of directed energy in medical applications where a cancer tumour can be specifically targeted, heated and destroyed deep within healthy tissue.) The technology could even be used for vector control of invertebrates, especially for mosquitos where the adult or the larvae (even in water) could be targeted.

Pesticides can be slow-acting, allowing viruses to be transmitted from pest to plant. MIHPC is fast acting, with immediate kill. MIHPC leaves no chemical residues, and is therefore suitable for use by organic farmers. It will be embraced by the organic community and the lack of toxic residues means that MIHPC has a low environmental impact. Treated pests can be absorbed safely into food webs, and treated crops into the food chain.

The MIHPC method does not involve the use of genetically modified techniques, and hence avoids the controversy perceived by many members of the public. Also, by targeting specific pests, insects that are of benefit to the farmer may be able to be left unharmed by the careful selection of the correct B-field characteristics. (Note: predator insects are generally larger than those being predated.)

RF magnetism is more suitable for agriculture than RF electromagnetic radiation (such as microwaves). Firstly, the dielectric effect that makes water molecules susceptible to microwaves is associated with the electric component (the E-field) of RF electromagnetic radiation, which RF magnetism does not have—MIHPC does not heat water, and can be used even in wet conditions. Secondly, E-fields (and all EMR) radiate away from their source, making them environmentally noisy (disruptive to communications). However, because of the very nature of magnetism, B-fields are localised close to their sources (i.e. close to their poles in the classical model of magnetism) and hence, more easily shielded.

### BRIEF DESCRIPTION OF DRAWINGS

The invention will now be described in more detail, by way of example only, with reference to the accompanying drawings in which:

FIG. 1 shows the electrical conductivity of animal material, which can be seen to be generally above 0.1 S/m. However, plant material generally has a conductivity an order or magnitude or two lower, and cannot be seen on the graph at this scale.;

FIG. 2 shows the electrical resistivity (the inverse of electrical conductivity), and the values for plant material can now be seen with respect to those of animal material;

FIG. 3 shows a graph of the variation between magnetic flux density (mT) with the magnetic field frequency (mHz) as a guide to quantitative B-field energy required to kill certain invertebrates:

FIG. 4 shows (simply) how magnetic induction heating for pest control (MIHPC) allows a magnetic field to be directed and targeted on a pest;

FIG. 5 shows the MIHPC device according to the invention, mounted on a tractor for agricultural crop use;

FIG. 6 shows the MIHPC device according to the invention, being used on a motorised trolley or suchlike for horticultural use;

FIG. 7 shows the MIHPC device according to the invention, incorporated into a hand-held can, such as an aerosol spray can;

FIG. 8 shows the MIHPC device according to the invention, incorporated into an overhead gantry, such as that used in the food packaging industry; and finally

FIG. 9 shows the MIHPC device according to the invention, incorporated into a grain flow pipe or similar, commonly used in grain harvesters, grain silos and for grain shipping.

Referring to the graph shown in FIG. 1, the electrical conductivity of animal material is generally an order of magnitude or two higher than that of plant material. Salt water, 0.5% by mass, has an electrical conductivity of about 0.8 S/m, similar to that of animal material. (For comparison, seawater has around 3.5% salt by mass, and thus a higher electrical conductivity of about 4 S/m.)

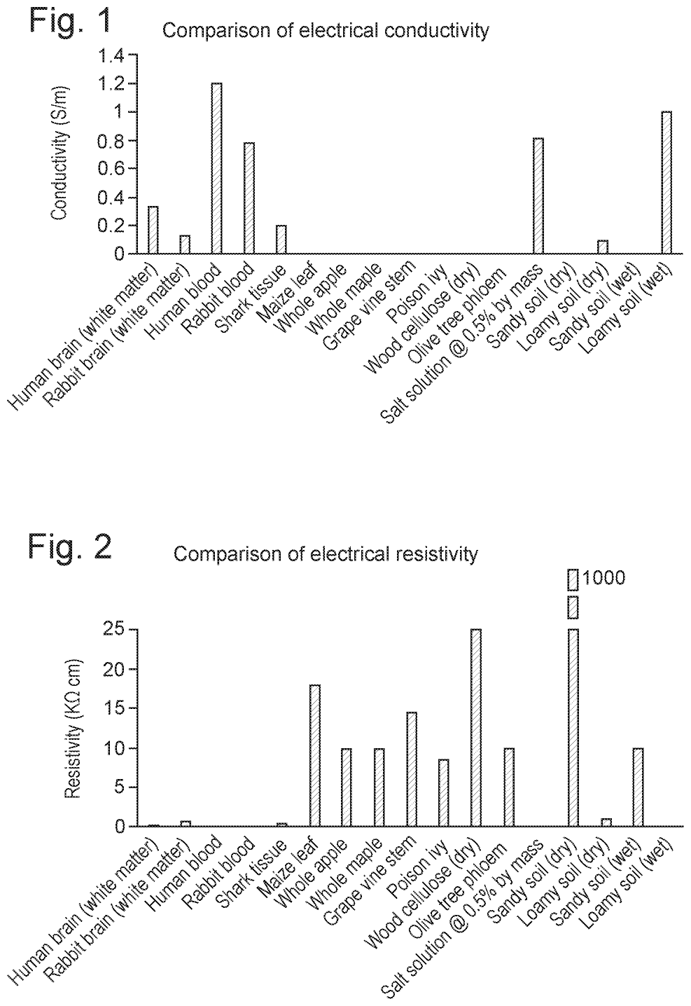

FIG. 2 shows the converse of this relationship, and thus by comparison of FIGS. 1 and 2, the electrical conductivity of animal material can be seen in the former, whereas the electrical resistivity of plant material is apparent in the latter.

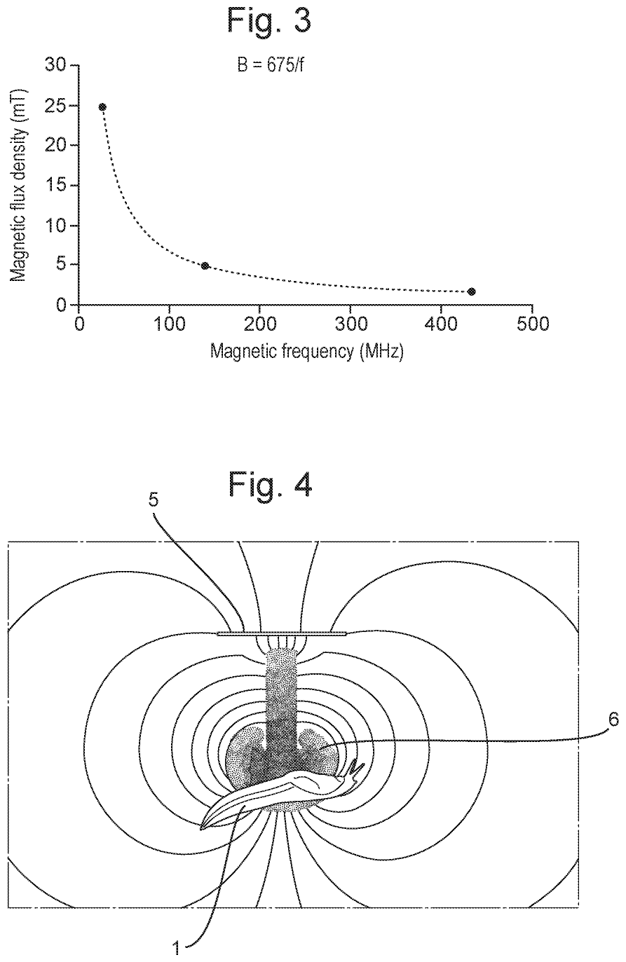

With reference to FIG. 3, it is currently thought that a magnetic flux density B=25 mT oscillating at a frequency f=27 MHz will deliver sufficient B-field inductive heating to kill a slug in one second, yet leave a lettuce unheated. Absorbed power p ∝ B² f² for any given sample and for a chosen absorbed power, B=constant/f. Therefore, for a field with B=25 mT and f=27 MHz, the respective constant=675 MHz·mT, and the relationship illustrated thus results.

FIG. 4 is a very simple illustration of the type of equipment needed for application of the MIHPC method of the present invention. A magnetic field generator 5 is specific to each application. The requirement is to generate a given frequency (generally megahertz frequency) at a given magnetic flux density (generally several tens of millitesla) to kill the target 1, but minimise collateral damage to the substrate upon which the target 1 lives (e.g. plant, wood, wall etc.). The magnetic field 6 can be focused by means of a magnetic lens or other design to produce a kill zone where the target 1 is located. The kill zone shape can be rectangular, conical, hemispherical or any other suitable geometry. Ideally the kill zone will be sharply defined such that any beneficial invertebrate outside the kill zone is not harmed. The target 1 can be any pest, vertebrate or invertebrate. However, the present invention is primarily aimed at invertebrates. Preferably, there will be an immediate killing knockdown of these, but sufficient damage to prevent breeding or feeding or any other operation may be acceptable. There may only be a deterrent effect required, for example to protect a valuable building against termite attack.

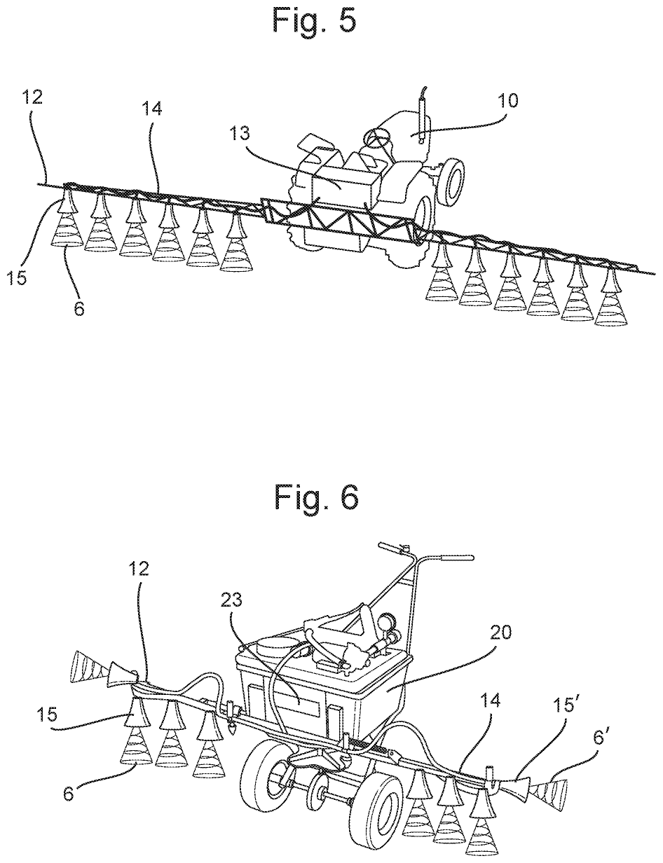

FIG. 5 illustrates application of the MIHPC method of the present invention for agricultural crop use and comprises a tractor or other propulsion device 10 having a boom or similar 12 connected to a high-tension power supply 13, run off a 24 V battery or using the vehicle's power supply, using power cabling 14. The boom or similar 12 is connected to one or more nozzles 15, which generate a magnetic field of 1 MHz-400 MHz frequency, millitesla to tens of millitesla field strength and are shielded against electromagnetic noise. The nozzles 15 produced a high-frequency magnetic field 6 focused on to invertebrate invested crops. The device according to the invention can easily be retrofitted onto existing farm machinery for killing invertebrate pests. This is similar to the FIG. 1 shown in WO8809616A1, except there the inventor used microwaves.

FIG. 6 illustrates application of the MIHPC method of the present invention for horticultural use. In this embodiment, a boom or other device 12, such as a sprayer is mounted on a movable trolley 20 which may be motorised or not. In this example, the boom or similar 12 is connected to a high tension power supply 23 run off a 24 V battery or mains supply, using power cabling 14. The boom or similar 12 is connected to one or more nozzles 15, 15′ which generate a magnetic field of 1 MHz-400 MHz frequency, millitesla to tens of millitesla field strength and are shielded against electromagnetic noise. A high-frequency vertical magnetic field 6, is focused on to invertebrate invested crops. In addition, one or more horizontal nozzles 15′ may be provided to generate a high-frequency horizontal magnetic field 6′, which is suitable for focusing on invertebrate invested grow bags or pots. The advantage of this embodiment is that it can be used for small plots or polytunnels. Furthermore, this embodiment, can also be used against vertebrates, e.g., killing moles or rats in the ground. This is similar to the FIG. 1 in patent U.S. Pat. No. 2,223,813A, which used an E-field generator as opposed to a B-field generator.

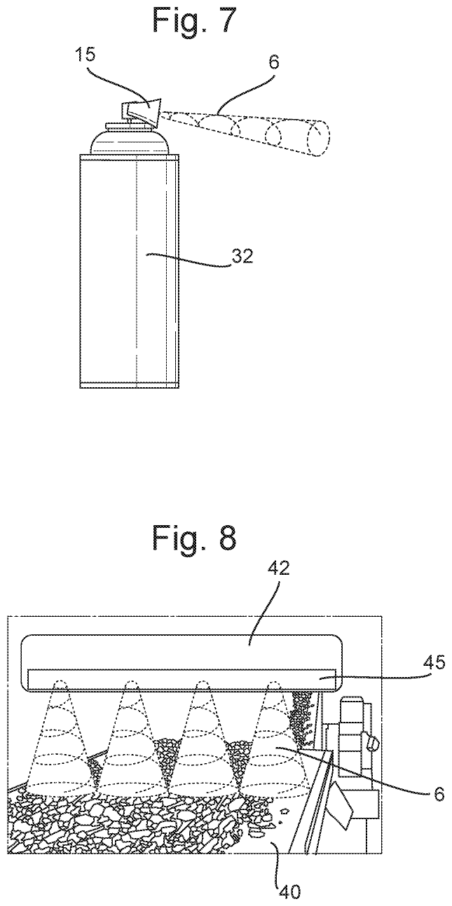

FIG. 7 illustrates application of the MIHPC method of the present invention to a simple hand-held tin 32 for personal use. Again, the tin 32 is connected to a high tension power supply run off low voltage rechargeable or other battery or power supply connected to a nozzle 15 to generate a magnetic field 6 of 1 MHz-400 MHz frequency, millitesla to tens of millitesla field strength and shielded against electromagnetic noise. This high frequency magnetic field 6 may be aimed at domestic invertebrate pests inside a house, or outside on paths or plants. In this embodiment, the device may be used for domestic pests including flies, ants, caterpillars, etc. in much the same way as a tin of aerosol spray.

FIG. 8 illustrates application of the MIHPC method of the present invention to food packaging lines comprising a propulsion device such as a conveyor belt 40, which transports a foodstuff in proximity to a gantry 42 containing a power supply and power cabling (not shown) to generate a high-frequency magnetic field 6 of 1 MHz-400 MHz frequency, millitesla to tens of millitesla field strength and shielded against electromagnetic noise. In this embodiment, the magnetic field generator 45 is integrated into the gantry 42. This embodiment of the invention can be used for packaging lines in third-party countries, and the magnetic field generator 45, such as a solenoid or other coil that circumscribes the entire food packaging conveyor belt 40. This is similar to the FIG. 5 in patent U.S. Pat. No. 2,485,660A, which used an E-field generator as opposed to a B-field generator.

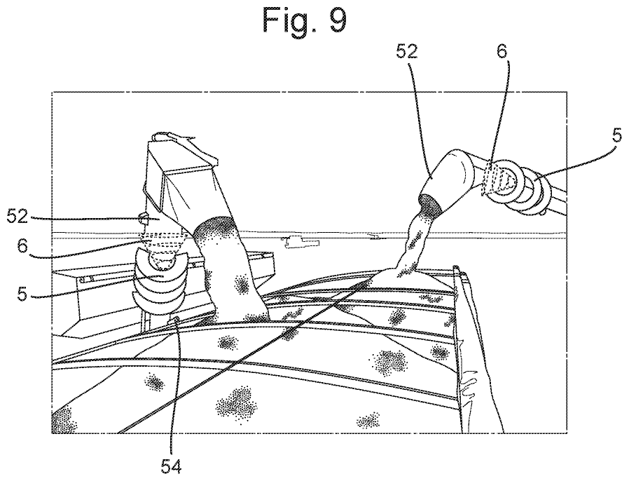

FIG. 9 illustrates application of the MIHPC method of the present invention to grain harvesters, grain silos, grain shipping or other produce flow, where pests (vertebrate or invertebrate) are present. In this embodiment of the invention, a grain handling device comprises a plastic or other non-conducting material grain flow pipe 52, one or more magnetic field generating device 5 to generate a high-frequency magnetic field/s 6 of 1 MHz-400 MHz frequency, millitesla to tens of millitesla field strength and shielded against electromagnetic noise. Another application for this current design in FIG. 9 is for treatment of invertebrate infestations in trees, as per the invention in U.S. Pat. No. 2,223,813A. However, the advantage of the present invention is that a B-field can penetrate deeper into the tree than an E-field, as tree sap (water) is transparent to B-fields and opaque to E-fields. This embodiment of the design can include an annular magnetic field generator 5, such as a solenoid or other coil that circumscribes the entire flow pipe 52.

Although several embodiments of the present invention have been described above, it will be apparent to those skilled in the art how the MIHPC method of the present invention may be optimised for other uses against various pests.

1-12. (canceled)

13. A method of pest control, the method comprising the steps of:
using irradiated energy of a sufficient strength to destroy or incapacitate a pest, whilst leaving a substrate plant or woody material unaffected,
wherein the irradiated energy comprises a magnetic field of optimized frequency, intensity and duration.

14. The method of claim 13, wherein the magnetic field is sufficient to provide magnetic induction heating of part or all of the pest, while leaving the substrate material unaffected.

15. The method of claim 14, wherein the magnetic field is sufficient to provide radio frequency magnetic induction heating.

16. The method of claim 13, wherein the magnetic field has a frequency of 0-1 GHz.

17. The method of claim 13, wherein the magnetic field has a frequency of frequency of 1 MHz-400 MHz.

18. The method of claim 13, wherein the magnetic field strength is 0-100 T, preferably millitesla up to tens of millitesla.

19. An apparatus for pest control comprising:
a high-frequency magnetic field generator connected to an electrical power supply.

20. The apparatus of claim 19, wherein the magnetic field generator further comprises at least one nozzle.

21. The apparatus of claim 19, wherein the apparatus includes a propulsion device adapted to direct a magnetic field onto a section of a substrate material.

22. The apparatus of claim 19, wherein the apparatus includes a magnetic lens to focus the magnetic field onto a kill zone containing a pest.

23. The apparatus of claim 19, wherein the apparatus shields against electromagnetic noise.

24. The apparatus of claim 19, wherein the magnetic field generator is shut down if the inductance is not what is expected.
